(19) United States
(12) Patent Application Publication
(10) Pub. No.: US 2023/0256622 A1
(43) Pub. Date: Aug. 17, 2023

(54) PICKUP TOOL ASSEMBLY

(71) Applicant: ILONANDRE PTY LTD, Queensland (AU)

(72) Inventor: Vaun TURNER, Queensland (AU)

(21) Appl. No.: 18/015,131

(22) PCT Filed: Mar. 25, 2021
(86) PCT No.: PCT/AU2021/050268

§ 371 Date: Jan. 9, 2023

(30) Foreign Application Priority Data
Jul. 7, 2020 (AU) 2020902325

(51) Int. Cl. B25J 15/06; B25J 1/04

(52) U.S. Cl. CPC B25J 15/0608; B25J 1/04

(57) ABSTRACT

A picking tool assembly for picking up ferrous metal debris, nails, screws, sheet metal fragments, staples, rivets, and other ferrous metal objects from an environmental surface, includes: a magnetic member movably disposed within a hollow tube assembly extending between an in-use upper end and in-use lower end. The magnetic member is mounted on a movable supporting assembly configured for being movably disposed within the internal volume defined by the hollow tube, and a handle is positioned at or adjacent to the upper end of the hollow tube. The handle is coupled with the supporting assembly by an elongated connector such that the upward and downward movement of the handle effects movement of the supporting member.

### TECHNICAL FIELD

The present invention relates a magnetic pickup device for picking up ferrous metal debris, such as nails, screws, sheet metal fragments, staples, rivets, and other ferrous metal objects from the ground or a floor, and particularly to a magnetic pickup device that rolls over the surface.

### BACKGROUND

Any references to methods, apparatus or documents of the prior art are not to be taken as constituting any evidence or admission that they formed, or form part of the common general knowledge.

During construction that uses formwork, it is often desirable to pick up metal debris such as such as nails, screws, sheet metal fragments, staples, rivets, and other ferrous metal objects that may be present in narrow holes or passages bored in such formwork.

Many magnetic pick-up devices currently exist in the market. However, these devices are relatively expensive because they are also complicated to manufacture. Devices that are currently known in the market require complicated mechanical arrangements for effecting movement of such prior art devices within narrow holes and bores. Furthermore, these arrangements also need to take into account a mechanism for releasing the magnetic debris captured by the prior art device. In view of the above, there is at least a need for providing alternative pick-up devices or tools that address some of the shortcomings of the prior art.

### SUMMARY OF INVENTION

In an aspect, the invention provides a picking tool assembly for picking up ferrous metal debris, nails, screws, sheet metal fragments, staples, rivets, and other ferrous metal objects from an environmental surface, the assembly comprising:
a magnetic member movably disposed within a hollow tube assembly extending between an in-use upper end and in-use lower end; wherein the magnetic member is mounted on a movable supporting assembly,
the supporting assembly being configured for being movably disposed within the internal volume defined by the hollow tube, and
a handle positioned at or adjacent the upper end of the hollow tube, the handle being coupled with the supporting assembly by an elongate connector such that upward and downward movement of the handle effects movement of the supporting member.

In an embodiment, the hollow tube assembly comprises a two-part configuration with a first hollow tube comprising said in-use upper end and the second hollow tube comprising said in-use lower end and wherein an in-use lower portion of the first hollow tube is adapted to be coupled to an in-use upper portion of the second hollow tube during use to allow axial movement of the supporting assembly within the internal volume of said first and second hollow tubes during use.

In an embodiment, the in-use lower portion of the first hollow tube is telescopically coupled with the in-use upper portion of the second hollow tube.

In an embodiment, the supporting assembly comprises a supporting member for limiting in-use upward and downward movement of the supporting member.

In an embodiment, the supporting member is positioned adjacent the magnetic member such that upward axial movement of the supporting assembly results in engagement between the supporting member and an internal abutment structure located along internal walls of the hollow tube assembly to engage the supporting member and limit upward axial movement of the supporting assembly.

In an embodiment, the internal abutment structure comprises an opening to allow the elongate connector to pass through during use and allow movement of the connector through the opening during axial movement of the supporting assembly.

In an embodiment, the supporting member is dimensioned to be prevented to pass through the opening of the internal abutment member.

In an embodiment, the hollow tube assembly further comprises a shielding sleeve located in a spaced arrangement relative to the in-use lower end of the hollow tube assembly such that axial movement of the magnetic member into an internal volume of the shielding sleeve prevents ferrous metal objects from being attracted towards the picking tool during use.

In an embodiment, the picking tool assembly further comprises an insulating sleeve adapted to be positioned within an internal volume of the shielding sleeve to prevent direct contact between the magnetic member and internal walls of the shielding sleeve.

In an embodiment, the insulating sleeve comprises a guiding portion extending from an in-use lower end of the insulating sleeve for guiding the magnet supporting member into the internal volume of the shielding sleeve.

In an embodiment, the overall length of the shielding sleeve (Ls) is at least two times and preferably three or more times the overall length of the magnetic member (L_{M}).

In an embodiment, the shielding sleeve comprises a metallic material for disrupting eddy currents in the shielding sleeve as the magnetic member moves through the shielding sleeve.

In an embodiment, the magnetic member is mounted to an end portion of the supporting member.

In an embodiment, the lower end of the hollow tube comprises a cap member, preferably a non-ferrous cap member for retaining the magnetic member in the hollow tube and for preventing the ingress of debris into the hollow tube assembly.

In an embodiment, the magnet supporting assembly is biased by a biasing member coupled with the supporting assembly for biasing the magnetic member in an in-use downwardly direction.

In an embodiment, the biasing member comprises a spring having two ends with a first end of the spring being coupled with the supporting assembly and a second end of the spring being coupled with an internal portion of the hollow tube assembly.

In an embodiment, the elongate connector is coupled to handle by an attachment member and wherein a body portion of the first hollow tube defines a groove to allow movement of the attachment member.

In an embodiment, the groove is configured to retain the attachment member in two operable configurations such that:
in a first operable configuration, the attachment member is retained in the groove at a first location such that the magnetic member, coupled to the attachment member via the elongate connector, is positioned at or adjacent the in-use lower end of the hollow tube assembly to attract ferrous objects to the in-use lower end by magnetisation; and
in a second operable configuration, the attachment member is positioned in the groove at a second location such that the magnetic member, coupled to the attachment member via the elongate connector, is positioned within the shielding sleeve to prevent ferrous objections from being attracted to the hollow tube by magnetisation.

In an embodiment, the groove is shaped to allow movement of the attachment member between the first location and the second location on the groove.

In an embodiment, the groove comprises a first groove portion with a first length extending between the first groove location and a second groove location and a second groove portion with a second length and bridging groove portion to connect the first and second groove portions to allow movement of the attachment member between the first and second groove portions.

In an embodiment, the first location of the groove is positioned at an in use lower end part of the first groove portion and the second location of the groove is positioned at an in-use upper end part of the first groove portion.

In an embodiment, in a third operable configuration, the attachment member is retained at a third groove location at an in-use lower end of the second groove portion such that the magnetic member, coupled to the attachment member via the elongate connector, is positioned within the shielding sleeve to prevent ferrous objections from being attracted to the hollow tube by magnetisation.

In an embodiment, the biasing member, during use, applies a biasing force on the attachment member coupled with the elongate connector to push attachment member against the lower end part of the first groove portion in the first position or against a lower end part of the second groove portion in the third position.

In another aspect, there is provided a tool assembly comprising:
a magnetic member movably disposed within a hollow tube assembly extending between an in-use upper end and in-use lower end; wherein the magnetic member is mounted on a movable supporting assembly;
the supporting assembly being configured for being movably disposed within the internal volume defined by the hollow tube;
wherein the hollow tube assembly further comprises an inner shielding sleeve located within an internal volume of the hollow tube assembly such that axial movement of the magnetic member into an internal volume of the shielding sleeve prevents ferrous metal objects from being attracted towards the hollow tube assembly.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a perspective view of the picking tool assembly 100 showing enlarged views of the handle 120 and the in-use lower end 1B.

FIG. 2 is an exploded view of the picking tool assembly 100. The hollow tube assembly 110 is shown to have indefinite length.

FIG. 3 is an enlarged perspective view (exploded) of the in-use lower end 1B of the picking tool assembly 100.

FIG. 4 is a sectional perspective view (exploded) of the in-use lower end 1B of the picking tool assembly 100.

FIG. 5 is a first sectional view of the tool assembly 100 showing the magnetic member 7 in an active magnetizing position.

FIG. 6 is a second sectional view of the tool assembly 100 showing the magnetic member 7 in an intermediate magnetizing position.

FIG. 7 is a third sectional view of the tool assembly 100 showing the magnetic member 7 in a non-magnetizing position whereby the magnetic member 7 has been axially moved into a substantially central internal volume portion of the shielding sleeve 130.

FIG. 8 is an enlarged perspective view (exploded) of the in-use upper end 1A of the picking tool assembly 100.

FIG. 9 is a first sectional view of the in-use upper end 1A of the tool assembly 100 showing the attachment pin 160 being positioned at the second groove portion 184 when the magnetic member 7 has been axially positioned within the shielding sleeve in a non-magnetizing position (shown in FIG. 7).

FIG. 10 is a second sectional view of the in-use upper end 1A of the tool assembly 100 showing the attachment pin 160 being positioned at the first lower groove location 182 when the magnetic member 7 in a magnetizing position (shown in FIG. 5).

FIG. 11 is a sectional view of the in-use upper end 1A of the picking tool assembly 100 showing the attachment pin 160 being positioned at the second upper groove location 185 when the magnetic member 7 in a non-magnetizing, general release position (shown in FIG. 7).

FIG. 12 is a sectional view of the in-use upper end 1A of the picking tool assembly 100 showing the attachment pin 160 being positioned at a second upper groove location 184 (held in a locked configuration) when the magnetic member 7 in a non-magnetizing position.

### DETAILED DESCRIPTION OF PREFERRED EMBODIMENTS

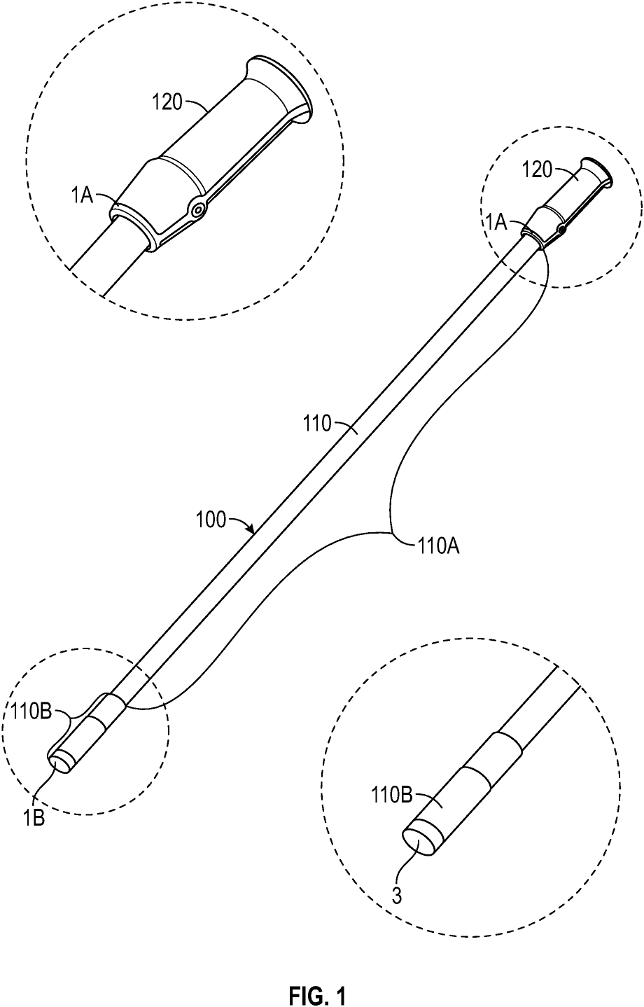

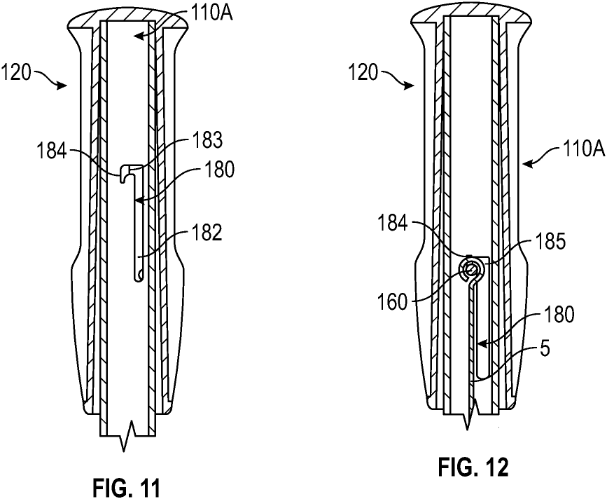

FIGS. 1 to 11 illustrate a picking tool assembly 100 in accordance with an embodiment of the present invention. The picking tool assembly 100 is particularly well adapted for picking up ferrous metal debris, nails, screws, sheet metal fragments, staples, rivets, and other ferrous metal objects. The assembly 100 comprises a hollow tube assembly 110 that extends between an in-use top end 1A and an in-use bottom end 1B.

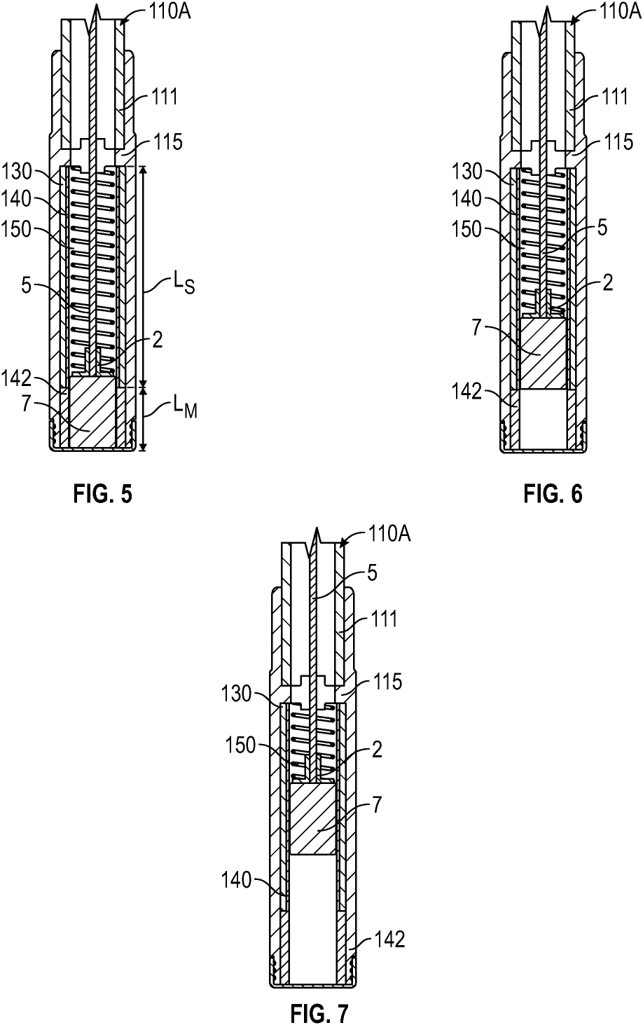

The hollow tube assembly 110 comprises a two-part configuration with a first hollow tube 110A comprising said in-use upper end 1A and the second hollow tube 110B comprising said in-use lower end 1B. The lower portion of the first hollow tube 110A is coupled to an in-use upper portion of the second hollow tube 110B via a telescopic arrangement shown clearly in sectional views of FIGS. 5 to 8. In the preferred embodiment, the lower end portion of the first hollow tube 110A is telescopically received into the in-use upper portion of the second hollow tube 110B. The first hollow tube 110A comprises an internal hollow volume within which there is provided a magnetic member 7 that is supported or affixed on a supporting assembly comprising a supporting member 2 (shown in FIGS. 2. 3 and 5 to 7). The supporting member 2 is connected to a handle 120 positioned at the upper end 1A of the hollow tube assembly 110 by an elongate connecting rod 5 that extends through a hollow internal volume of the first hollow tube 110A and connects with the supporting member 2 positioned within the second hollow tube 110B.

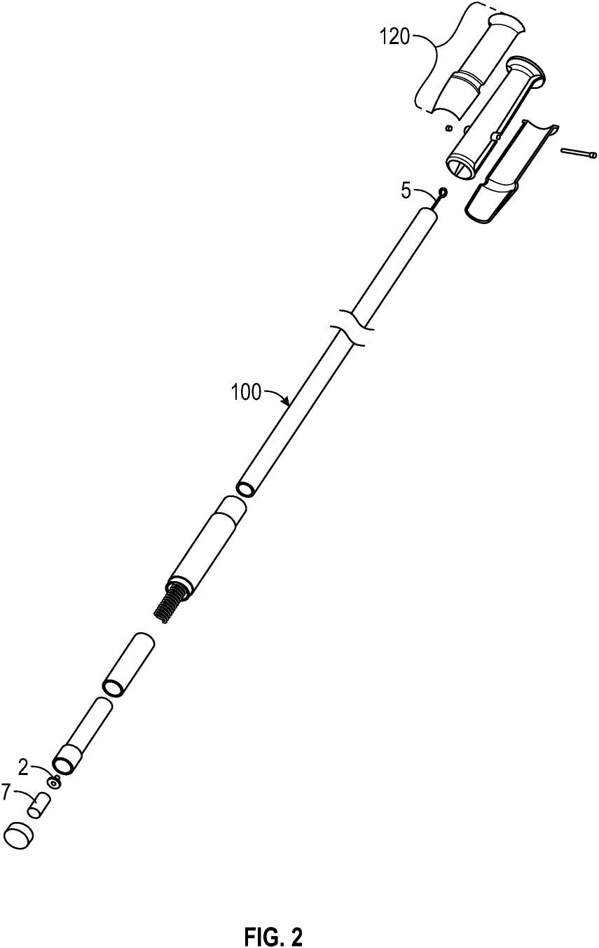

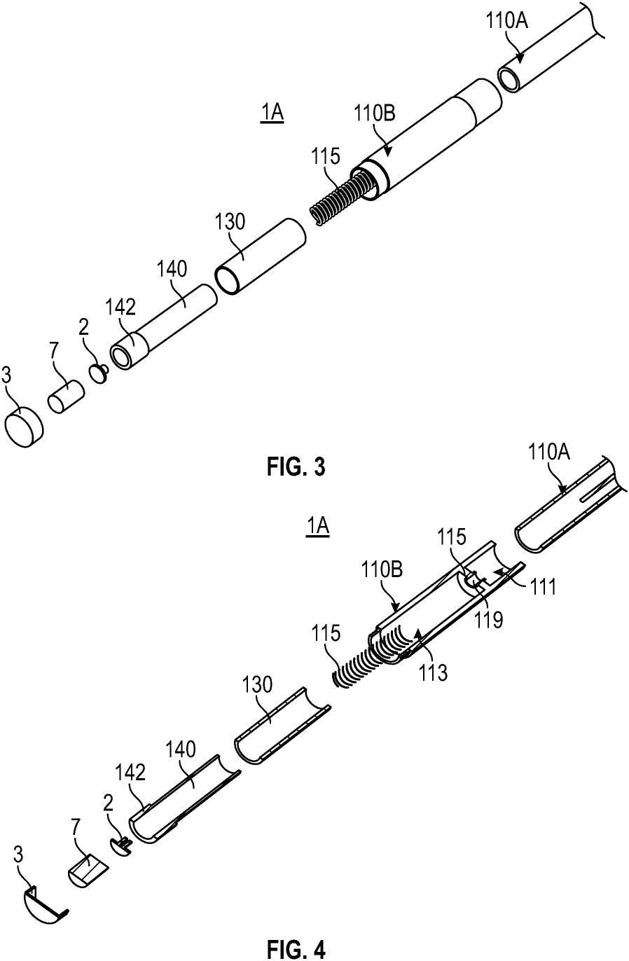

Referring particularly to FIGS. 3 to 7, the supporting member 2 is shaped in the form of a solid disc attached to the magnetic member 7 to function as a limiting member (the stop is the pin 160 hitting against the top of the groove 180) by engaging an internal abutment structure 115 located along internal walls of the second hollow tube 110B through the biasing member 130 such that the abutment of the internal abutment structure 115 with the supporting member 2 resists upward axial movement of the magnetic member 7 within the internal volume of the second hollow tube 110B when pulled in an upward direction by the handle 120. Importantly, the disc shaped body of the supporting member is coupled to handle 120 via the elongate connector rod 5 such that any upward pulling force resulting in upward movement of the handle assembly 120 results in the connecting rod 5 and the magnet supporting assembly 2 and the magnet 7 being pulled in an upwardly direction until the pin 160 abuts the internal abutment structure 185(needs to be added) of the groove 180. The internal abutment structure 115 is provided with a narrow opening 119 (best shown in FIGS. 4 to 7) to allow the connecting rod 5 to pass through whilst undergoing axial movement when the handle 120 is being pulled.

Referring to FIGS. 3 to 7, the second hollow tube 110B comprises an internal volume that is divided into two internal chambers 111 and 113 such that the internal abutment structure 115 effectively separates the two internal chambers 111 and 113. The first internal chamber 111 receives the first hollow tube 110A and the second internal chamber 113 receives a shielding sleeve 130 (made preferably from metal to shield the magnetic member 7 and significantly lower the magnetic field of the magnetic member 7) that substantially engages inner walls of the second internal chamber 113 and functions as a magnetic shield when the magnetic member 7 is positioned within an internal volume of the shielding sleeve 130. Axial movement of the magnetic member 7 into a substantially central volume portion of the shielding sleeve 130 results in the magnetic member 7 being shielded which in turn prevents ferrous metal objects from being attracted towards the picking tool 100 during use (best shown in FIG. 7). The lower end of the shielding sleeve 130 is spaced away from the lower end 1B of the hollow tube assembly 110 so that there is sufficient volume for the magnetic member 7 to be positioned at or adjacent the lower end 1B and be operable in a magnetising configuration (when the magnetic member 7 is substantially located outside the internal volume of the shielding sleeve 130(best shown in FIG. 5). In an intermediate configuration(shown in FIG. 6), the magnetic member 7 may be positioned at or adjacent a lower end of the internal volume of the second chamber 113. It has been found by the inventors that even when the magnetic member 7 is positioned inside the internal volume of the shielding sleeve, the shielding effect of the sleeve 130 is effective only when the entire length of the magnetic member 7 is substantially located in the central portion of the internal volume of the sleeve 130. As a result, it is important that overall length of the shielding sleeve (Ls) is at least two times and preferably three times the overall length of the magnetic member (L_{M}).

The picking tool 100 also comprises an insulating sleeve 140 that is sized to be positioned within an internal volume of the shielding sleeve to prevent direct contact between the magnetic member and internal walls of the shielding sleeve 130. In order to allow the shielding sleeve 130 to be spaced away from the lower end 1B of the hollow tube assembly 110 (which allows the magnetic member 7 to be positioned in a magnetising configuration), a guiding portion 142 extends from an in-use lower end of the insulating sleeve 140 for guiding the magnet supporting member 2 and magnetic member 7 into and out of the the internal volume of the shielding sleeve 130. In the magnetising position, the entire length of the magnetic member 7 is positioned within the volume of the guiding portion 142 which allow ferrous metal debris to be attracted to the lower end 1B of the hollow tube assembly 110. An end cap 3 is also provided at the second end 1B adjacent the lower end of the guiding portion 142 to prevent any debris from entering the hollow volume of the second guiding portion 142 during use.

A biasing member in the form of a biasing spring 150 is also provided in a coupled arrangement with the supporting member 2 within the insulating sleeve 140 to apply a biasing force on the magnetic member 7 (coupled to the supporting member 2) in a downward direction such that the spring 150 pushes the magnetic member 7 towards the end cap 3. The spring 150 comprises two ends with a first end of the spring being coupled with the supporting assembly 2 and a second end of the spring being coupled with the internal abutment structure 115 (best shown in FIGS. 5 to 7).

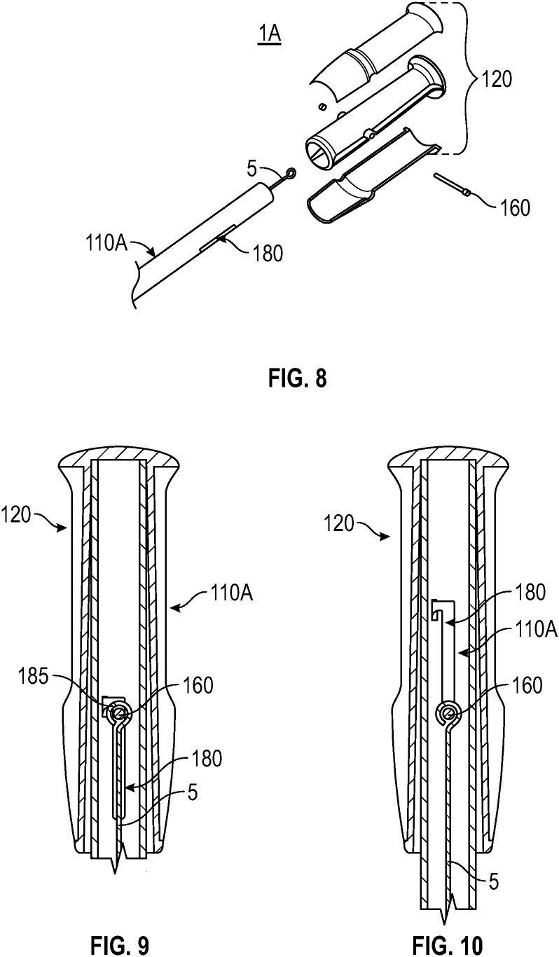

Referring to FIGS. 8 to 11. the connecting rod 5 is coupled to the handle by an attachment member in the form of an attachment pin 160. The attachment pin 160 is structured to engage an end portion 52 of the connecting rod 5. The attachment pin 160 is also coupled with the handle assembly 120 whereby upward movement of the handle assembly 120 results in a pulling force being applied on the connecting rod 5. In order to effect upward movement of the magnetic member 7 and the supporting member 2, the pulling force needs to overcome the biasing force applied by the spring 150. An upper portion of the first hollow tube 110A comprises a groove 180 which allows movement of the attachment pin 160 between a first location (when the handle assembly 120 coupled to the attachment pin 160 is pulled in an upward direction-See FIG. 9) and a second location (when the handle assembly 120 is allowed to retract in a downward direction under the biasing force of the spring 150-See FIG. 10).

The groove 180 is configured to retain the attachment pin 160 in two operable configurations. In a first operable configuration, the attachment pin 160 is retained in the groove 180 at the first location such that the magnetic member, coupled to the attachment member via the elongate connecting rod 5, is positioned at or adjacent the in-use lower end 1A of the hollow tube assembly 110 to attract ferrous objects to the in-use lower end 1B by magnetisation as shown in FIG. 10. In a second operable configuration, the attachment pin 160 is held or retained in the groove 180 at a second location 185 such that the magnetic member 7 coupled to the attachment pin 160 via the elongate connecting rod 5, is positioned within the shielding sleeve 130 to prevent ferrous objections from being attracted to the hollow tube assembly 110 by magnetisation. The groove 180 comprises a first groove portion 182 with a first length and a second groove portion 184 with a second length and bridging groove portion 183 to connect the first and second groove portions to allow movement of the attachment pin 160 between the first and second groove portions 182 and 184. As shown clearly in FIGS. 9 to 11, the first location of the groove 180 is positioned at an in use lower end part of the first groove portion 182 and the second location of the groove is positioned at an in-use upper end part of the first groove portion 182. The biasing spring 150, during use, applies a biasing force on the attachment pin 160 (coupled with the connecting rod 5) to push the attachment pin 160 against the lower end part of the first groove portion 182 or the second groove portion 184 (at a third groove location in a locked non magnetising configuration). The aforementioned arrangement allows the user to pull the handle assembly 120 in an upward direction and apply a slight twist to move the attachment pin from the first groove 182 into the second groove 184 and then withdraw the pulling force which results in the attachment pin 160 being retained at a lower end of the second groove 184 thereby allowing the magnetic member 7 to be retained in the shielding sleeve 130 over long periods time (such as when being transported or shipped) in a locked configuration. Similarly, the provision of the groove 180 also allows the user to simply apply a twisting action to position the attachment pin 160 into the first groove portion 182 to deploy the magnetic member 7 into a magnetising configuration without the need to continuously push the handle in a downward direction to maintain the magnetising configuration.

The picking tool assembly 100 also provides a ferrous debris removal tool that is easy and inexpensive to manufacture with very few moving parts and improved use when compared with some of the prior art devices.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1-24. (canceled)

25. A picking tool assembly for picking up ferrous metal debris, nails, screws, sheet metal fragments, staples, rivets, and other ferrous metal objects from an environmental surface, the assembly comprising:
a magnetic member movably disposed within a hollow tube assembly extending between an in-use upper end and in-use lower end;
wherein the magnetic member is mounted on a movable supporting assembly,
the supporting assembly being configured for being movably disposed within the internal volume defined by the hollow tube, and
a handle positioned at or adjacent the upper end of the hollow tube, the handle being coupled with the supporting assembly by an elongate connector such that upward and downward movement of the handle effects movement of the supporting member;
wherein the hollow tube assembly comprises: an inner shielding sleeve such that axial movement of the magnetic member into an internal volume of the shielding sleeve prevents ferrous metal objects from being attracted towards the hollow tube assembly, and an insulating sleeve adapted to be positioned within an internal volume of the shielding sleeve to prevent direct contact between the magnetic member and internal walls of the shielding sleeve.

26. The picking tool assembly according to claim 25, wherein the hollow tube assembly comprises a two-part configuration with a first hollow tube comprising said in-use upper end and the second hollow tube comprising said in-use lower end and wherein an in-use lower portion of the first hollow tube is adapted to be coupled to an in-use upper portion of the second hollow tube during use to allow axial movement of the supporting assembly within the internal volume of said first and second hollow tubes during use and
wherein the in-use lower portion of the first hollow tube is telescopically coupled with the in-use upper portion of the second hollow tube.

27. The picking tool assembly according to claim 25, wherein the supporting assembly comprises a supporting member for limiting in-use upward and downward movement of the supporting member.

28. The picking tool according to claim 27, wherein during use the supporting member of the supporting assembly is positioned adjacent the magnetic member such that upward axial movement of the supporting assembly results in engagement between the supporting member and an internal abutment structure located along internal walls of the hollow tube assembly to resist the supporting member and resist upward axial movement of the supporting assembly.

29. The picking tool according to claim 28, wherein the internal abutment structure comprises an opening to allow the elongate connector to pass through during use and allow movement of the connector through the opening during axial movement of the supporting assembly.

30. The picking tool assembly according to claim 29, wherein the supporting member is dimensioned to be prevented to pass through the opening of the internal abutment member.

31. The picking tool assembly according to claim 25, wherein the shielding sleeve is located in a spaced arrangement relative to the in-use lower end of the hollow tube assembly.

32. The picking tool according to claim 25, wherein the insulating sleeve comprises a guiding portion extending from an in-use lower end of the insulating sleeve for guiding the magnet supporting member into the internal volume of the shielding sleeve.

33. The picking tool according to claim 25, wherein an overall length of the shielding sleeve is at least two times the overall length of the magnetic member.

34. The picking tool according to claim 25, wherein the shielding sleeve comprises a metallic material for disrupting eddy currents in the shielding sleeve as the magnetic member moves through the shielding sleeve.

35. The picking tool assembly according to claim 25, wherein the magnetic member is mounted to an end portion of the supporting member.

36. The picking tool assembly according to claim 25, wherein the lower end of the hollow tube comprises a cap member for retaining the magnetic member in the hollow tube and for preventing the ingress of debris into the hollow tube assembly.

37. The picking tool assembly according to claim 25, wherein the magnet supporting assembly is biased by a biasing member coupled with the supporting assembly for biasing the magnetic member in an in-use downwardly direction.

38. The picking tool assembly according to claim 37, wherein the biasing member comprises a spring having two ends with a first end of the spring being coupled with the supporting assembly and a second end of the spring being coupled with an internal portion of the hollow tube assembly.

39. The picking tool assembly according to claim 25, wherein the elongate connector is coupled to handle by an attachment member and wherein a body portion of the first hollow tube defines a groove to allow movement of the attachment member.

40. The picking tool assembly according to claim 39, wherein the groove is configured to retain the attachment member in two operable configurations such that:
in a first operable configuration, the attachment member is retained in the groove at a first location such that the magnetic member, coupled to the attachment member via the elongate connector, is positioned at or adjacent the in-use lower end of the hollow tube assembly to attract ferrous objects to the in-use lower by magnetization; and
in a second operable configuration, the attachment member is positioned in the groove at a second location such that the magnetic member, coupled to the attachment member via the elongate connector, is positioned within the shielding sleeve to prevent ferrous objections from being attracted to the hollow tube by magnetization; and
wherein the groove is shaped to allow axial movement of the attachment member between the first location and the second location on the groove.

41. The picking tool assembly according to claim 40, wherein the groove comprises a first groove portion with a length extending between the first groove location and the second groove location and a second groove portion with a second length and bridging groove portion to connect the first and second groove portions to allow movement of the attachment member between the first and second groove portions.

42. The picking tool assembly according to claim 41, wherein the first location of the groove is positioned at an in use lower end part of the first groove portion and the second location of the groove is positioned at an in-use upper end part of the first groove portion.

43. The picking tool assembly according to claim 41, wherein in a third operable configuration, the attachment member is retained at a third groove location at an in-use lower end of the second groove portion such that the magnetic member, coupled to the attachment member via the elongate connector, is positioned within the shielding sleeve to prevent ferrous objections from being attracted to the hollow tube by magnetization; and
wherein the biasing member, during use, applies a biasing force on the attachment member coupled with the elongate connector to push attachment member against the lower end part of the first groove portion or the second groove portion.

44. A tool assembly comprising:
a magnetic member movably disposed within a hollow tube assembly extending between an in-use upper end and in-use lower end; wherein the magnetic member is mounted on a movable supporting assembly;
the supporting assembly being configured for being movably disposed within the internal volume defined by the hollow tube;
wherein the hollow tube assembly further comprises: an inner shielding sleeve located within an internal volume of the hollow tube assembly such that axial movement of the magnetic member into an internal volume of the shielding sleeve prevents ferrous metal objects from being attracted towards the hollow tube assembly, and an insulating sleeve adapted to be positioned within an internal volume of the shielding sleeve to prevent direct contact between the magnetic member and internal walls of the shielding sleeve.
